(19) United States
(12) Patent Application Publication
(10) Pub. No.: US 2002/0194266 A1
(43) Pub. Date: Dec. 19, 2002

(54) Device and method for outputting location information

(76) Inventors: Gavin Brebner, St. Martin D'Uriage (FR); Marcus A. Smith, Boise, ID (US)

Correspondence Address: LADAS & PARRY, Suite 2100, 5670 Wilshire Boulevard, Los Angeles, CA, 90036-5679, US

(21) Appl. No.: 09/881,211

(22) Filed: Jun. 14, 2001

(51) Int. Cl. G06F 15/16

(52) U.S. Cl. 709/203; 709/246; 358/1.15

(57) ABSTRACT

A network-connected printer (26) or other hard-copy device is arranged to receive location data, for example via an infrared interface (33), and store it in memory (32). The printer (26) is provided with a location server (36) enabling other devices on the network (27) to query the printer for its location; preferably, the location server is an HTTP server. The printer 26 can contact a conversion service (29) in order to change the form of its location data, for example, from latitude and longitude values to a building-semantics form.

### FIELD OF THE INVENTION

The present invention relates to devices and methods for outputting location information; in particular, but not exclusively, the present invention relates to hard-copy output devices for receiving, storing and outputting location data. As used herein, the term “hardcopy output device” is intended to include printers, plotters, copiers and other devices that provide data output in tangible form.

### BACKGROUND OF THE INVENTION

The automatic availability to devices of location information is becoming increasingly common and a number of techniques are known for making such information available. For example, it is known to disseminate location information using fixed-position beacons and FIG. 1 depicts a typical arrangement using infrared beacons (IRB) 11 to transmit location information to a mobile device 20A provided with an infrared receiver. Other wireless technologies, such as short-range radio systems (in particular, “Bluetooth” systems) may be used in place of the infrared system depicted in FIG. 1 for transmitting the location information from the beacons 11.

FIG. 1 also depicts the diffusion of location information from mobile device 20A to a second mobile device 20B over a short-range radio link. Methods and devices for diffusing location information are described in our co-pending UK patent applications GB 0006589.6 and GB 0017456.5, the methods described in the latter Application taking account of the movement of mobile entities between receiving and passing on location information.

Another known technique for obtaining location information is to use the satellite-based Global Positioning System (GPS). As shown in FIG. 2, a mobile entity 20C provided with a standard GPS module is capable of determining its location by picking up signals from satellites 12. Using this system, highly accurate location information can be obtained though performance can be severely affected within buildings.

A less accurate but more robust radio-based location-determining technique relies on signals present in a cellular radio infrastructure such as PLMN 15 (see FIG. 3). More particularly, it is possible to get a location fix by measuring timing and/or directional parameters between a mobile entity 20D and multiple Base Transceiver Stations (BTSs) 13 associated with the same base Station Controller (BSC) 14. These measurement can be done either in the network or the mobile entity.

In office environments location information can be useful for a number of purposes such as determining the correct office address (useful for visitors with mobile devices) and pin-pointing the location of particular resources. It may be noted that in such a context, the location information is preferably available, not as geographic coordinates (e.g. latitude and longitude) but in a form with semantic meaning, such as a street address or a building, floor and pillar designation.

It is known to provide for the storage in a printer of a manually input text string that specifies the printer's location and is retrievable over a connected network by a printer driver program installed on a networked PC.

It is an object of the present invention to facilitate the provision of location information in an office and similar environments.

### SUMMARY OF THE INVENTION

According to a first aspect of the present invention, there is provided a hardcopy output device including a memory for storing location data, a location-data input arrangement for receiving and storing location data in the memory, a network interface, and an HTTP location server for responding to client requests received via the network interface to return location information comprising, or derived from, the location data stored in memory.

According to a second aspect of the present invention there is provided a hard-copy output device including a wireless interface for receiving data, a memory, a location-data input manager for receiving location data via the wireless interface and storing it in the memory, a network interface, and a location server for responding to client requests received via the network interface to return location information comprising, or derived from, the location data stored in memory.

According to a third aspect of the present invention, there is provided a hard-copy output device including a memory, a location input subsystem for receiving location data and storing it in said memory, and a location output subsystem for accessing the stored location data and outputting it; at least one of the location input and output subsystems being operative to convert the location data it handles between a first form and a second form, one of the first and second forms being a semantic location form and the other a form based on geographic coordinates.

### BRIEF DESCRIPTION OF THE DRAWINGS

Embodiments of the invention will now be described, by way of non-limiting example, with reference to the accompanying diagrammatic drawings, in which:

FIG. 1 is a diagram illustrating a first known location-discovery method using fixed location beacons;

FIG. 2 is a diagram illustrating a second known location-discovery method using GPS satellites;

FIG. 3 is a diagram illustrating a second known location-discovery method using measurements made in a cellular radio system;

FIG. 4 is a diagram of a first embodiment of the present invention in which a networked printer is provided with a location server; and

FIG. 5 is a table illustrating when it is appropriate to effect conversions between geographic and semantic location data.

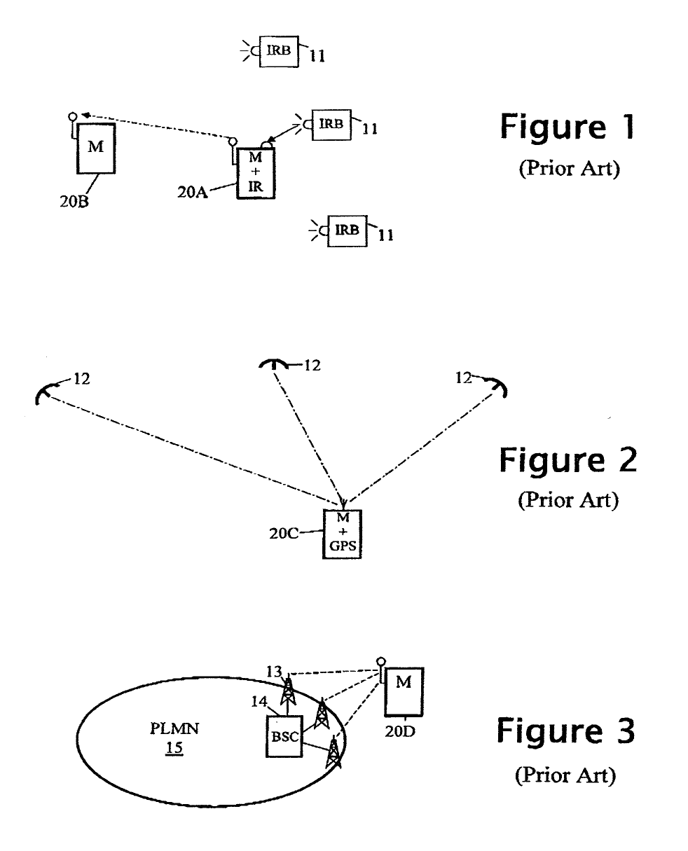

### BEST MODE OF CARRYING OUT THE INVENTION

Because of the way they are used, hard-copy output devices, such as printers, are useful location reference points in offices. Thus, a printer may be connected to an individual PC in which case it is a useful location reference point for that PC and its user. Alternatively, the printer may be arranged to serve as a workgroup printer, typically being connected to a LAN segment to which user PCs are also connected; in this case the printer is generally centrally disposed to be conveniently available to all its intended users and will therefore also serve as a convenient location reference for the workgroup.

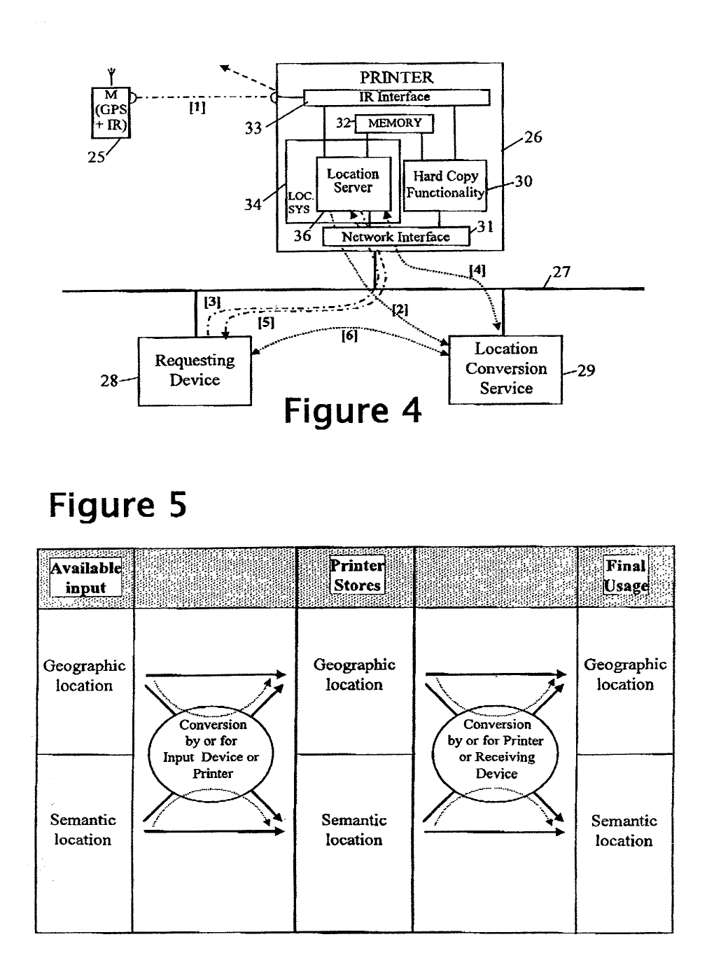

According to the embodiment of the invention shown in FIG. 4, a hard-copy device, here shown as a printer 26, is arranged to receive and store location data representing its location from a mobile entity 25 over a wireless link (for example an infrared link). The printer 26, which is connected to LAN 27, is further arranged to serve the location data over the LAN to a requesting device 28. The printer 26 and the requesting device 28 can also each access a LAN-connected server 29 running a location conversion service for converting location data between different forms—in particular, between geographic coordinate form and semantic form and vice versa. The location conversion service is preprogrammed with mappings between one or more forms of geographic coordinate data and one or more forms of semantic data.

Considering the printer 26 in more detail, the printer comprises standard hard-copy functionality 30 by which data for printing, received either over the LAN 27 via a network interface 31 or over an IR link via IR interface 33, is stored in memory 32, processed and then printed. The printer 26 further comprises a location subsystem 34 which in the present embodiment is embodied as an HTTP server 36 with supporting service code. The location server is arranged to receive location data from the IR interface 33 (in HTTP request messages) and store it in memory 32. The location server 36 is connected via network interface 31 to LAN 27 and can respond to location requests received over the LAN. The location server 36 can also access the location conversion service provided by server 29.

More particularly with respect to the transfer of location data from he device 25 to the location server 36, this is preferably done using a protocol such as OBEX which is a “binary” version of HTTP (lighter weight and more appropriate for an IR or other wireless link). In communication with HTTP server 36 over an infrared link, one can either use the default OBEX server as the “middleman”, simply tunnelling the requests to the HTTP server or ‘TinyTP’ directly (‘TinyTP’ being the transport typically used in infrared transport stack). In fact, the OBEX protocol includes a bit inside the header field to denote that the information following is actually HTTP and therefore should just be routed to the HTTP server by either loopback, IPC or some other mechanism. The preferred way to communicate with the HITP server is to tunnel through OBEX.

Use of the location features of the printer 26 will now be described with reference to arrowed operations [1] to [6] in FIG. 4:

[1] An operator uses mobile device 25 to determine the location of the printer, the mobile device 25 being equipped with a GPS system or other system for determining the location of the printer, typically in geographic coordinate form. The determined location is then transmitted to the printer in an HTTP request message via the infrared link. The IR interface 33 of the printer determines that the received message is intended for the location server and passes it to the location server 36.

[2] The location server 36 determines whether or not the form of the location data is appropriate for storage. For example, if the location data is received as latitude and longitude readings but the printer is set to store location data in building semantic form (floor, pillar number), then the location server 36 contacts the location conversion service, providing the latter with the latitude and longitude readings and asking for the return of location data in building-semantics form. Alternatively, the location data may have been transmitted to the printer in building-semantics form whilst the printer is set to store the location data in latitude and longitude form; in this case, the location server 36 again uses the conversion service but this time to effect the reverse conversion to the previous example. Upon the location server 36 receiving back the location data from server 29 in an appropriate form (or directly if the data is already in the correct form as supplied by the mobile device 25), the location server 36 stores the received location data to memory 32.

[3] Device 28 makes a request over the LAN 27 for the location of the printer 26; in the present example, this request is in the form of an HTTP request, using the GET method, for a default location page containing the location data for the printer. The HTTP request is passed to the location server 36. The request can be arranged to specify the form in which the location data is to be supplied.

[4] Where the location data is to be provided in a form different to that in which it is held in memory 32, the location server 36 contacts the location conversion service to have the latter carry out the desired conversion

[5] The location server 36 returns the location data in the required form to the requesting device 28 in an HTTP response message.

[6] Finally, the requesting device can have the conversion service effect a (further) conversion of the form of the location data

From the foregoing, it will be appreciated that use of the conversion service may be made at several different stages and FIG. 5 provides a tabular depiction of when such conversion is appropriate having regard to the form of location data supplied by mobile device, the form used to store the location data in memory 32 and the form required by the device 28. In certain cases, it is possible that the conversion to be effected is from one geographic coordinate form to another or from one semantic form to another and this is illustrated by the dashed arrows in FIG. 5.

The location data supplied to the printer 26 for storage will generally be supplied when the printer is first installed and whenever the printer is subsequently moved. As regards location updating, the simplest update policy for the location server 36 to implement is always to accept new location information and use it to overwrite existing location data held in memory 32. This policy can, however, lead to a decrease in accuracy of the stored location data—for example, where the new location data is derived using a less accurate technique and originally employed (the printer not having been moved) or where location-data transmission is delayed with respect to location deter on and the mobile device is moved between the two events so that the location data does not reflect the true position of the printer. Preferably, therefore, the location data transmitted by the mobile device 25 has an associated reliability indicator giving an indication of the likely accuracy of the location data. The location server 36 can then use this reliability indicator in deciding whether or not to accept the update. Where the new location data indicates, in comparison with the stored location data, that the printer has been moved beyond the bounds of inaccuracy of the new reading, then the new location data should generally be accepted. Where the difference between the new location data and stored location data is within the bounds of inaccuracy of the new data, then provided the reliability indicator of the old location data has also been stored, the location server handler can decide whether or not to overwrite the old data with the new location data simply on the basis of which is most accurate. In fact, provided the new location data is of reasonably high accuracy, it is probably good policy always to use this data to overwrite the existing location data.

In one implementation, the reliability indicator indicates whether the location data has been received directly from an entity with a primary source of location data (such as a GPS module) or from an entity which itself received the data from another entity (for example, by wireless diffusion), the location server 36 preferentially storing or retaining location data received directly from an entity with a primary source of location data.

Additionally or alternatively to using the IR link for supplying location data to the location server 36, other location input methods can be used. For example, the location data can be stored in the printer memory by an input handler connected to the infrared interface rather than passing through the location server (that is, the functionality which serves to provide a location input subsystem, is moved from server 36 into a separate entity). Furthermore, rather than using an infrared link, the location data can be provided over the network (in an HTTP request message or otherwise). A typical scenario in which location data is supplied in this manner is where an operator uses their workstation to input the location of a printer in building-semantics form, the location server 36 then using the conversion service to change the location data into latitude and longitude values for storing in the memory 32.

It will be appreciated that many variants are possible to the above described embodiments of the invention.

It may be noted that the hardcopy functionality of the printer 26 (or other hard-copy device provided with location data) can be arranged, in response to codes embedded in data to be printed, to retrieve the location data from memory 32 and insert it in the data for printing. The form which the location data should take in the printed out can also be specified in the embedded codes and the hard-copy functionality can be arranged to contact the conversion service to effect any required conversion.

1. A hard-copy output device including:
a memory for storing location data,
a location-data input arrangement for receiving and storing location data in the memory,
a network interface, and
an HTTP location server for responding to client requests received via the network interface to return location information comprising, or derived from, the location data stored in memory.

2. A device according to claim 1, wherein the input arrangement comprises a wireless interface for receiving the location data and an input manager for storing in the memory location data received over the wireless interface.

3. A hard-copy output device including:
a wireless interface for receiving data,
a memory,
a location-data input manager for receiving location data via the wireless interface and storing it in the memory,
a network interface, and
a location server for responding to client requests received via the network interface to return location information comprising, or derived from, the location data stored in memory.

4. A device according to claim 2 or claim 3, wherein the input manager is operative to cause the form of the received location data to be converted from a first form to a second form prior to storage in said memory, one of the first and second forms being a semantic location form and the other a form based on geographic coordinates.

5. A device according to claim 4, wherein the input manager effects said conversion by using a conversion service which it contacts over the network.

6. A device according to any one of claims 1 to 3, wherein the location server is operative to cause the form of the stored location information to be converted from a first form to a second form for output in response to a said client request, one of the first and second forms being a semantic location form and the other a form based on geographic coordinates.

7. A device according to claim 6, wherein the location server effects said conversion by using a conversion service which it contacts over the network.

8. A device according to claim 1 or claim 2, wherein the received location data includes a reliability indicator which the input manager uses to determine whether or not to overwrite existing location data, if any, held in said memory.

9. A device according to claim 8, wherein where the input manager decides to store the newly received location data, the related reliability indicator is also stored, the input manager when determining whether to store newly received location data, taking account of the relative reliabilities of the stored and newly received information as indicated by their related reliability indicators.

10. A device according to claim 9, wherein said reliability indicator indicates whether the location data has been received directly from an entity with a primary source of location data or from an entity which itself received the data from another entity, the input manager preferentially storing or retaining location data received directly from an entity with a primary source of location data.

11. A hard-copy output device including:
a memory,
a location input subsystem for receiving location data and storing it in said memory, and
a location output subsystem for accessing the stored location data and outputting it; at least one of the location input and output subsystems being operative to convert the location data it handles between a first form and a second form, one of the first and second forms being a semantic location form and the other a form based on geographic coordinates.

12. A device according to claim 11, wherein the input subsystem receives location data in the form of geographic coordinates and converts the location data into semantic form.

13. A device according to claim 11, wherein the input subsystem receives location data in semantic form and converts the location data into geographic coordinates.

14. A device according to claim 12 or claim 13, wherein the input subsystem effects said conversion by using a remote conversion service.

15. A device according to claim 11, wherein the stored location data is in the form of geographic coordinates and the output subsystem converts this location data into semantic form before outputting it.

16. A device according to claim 11, wherein the stored location data is in the form of geographic coordinates and the output subsystem converts this location data into geographic coordinates before outputting it.

17. A device according to claim 15 or claim 16, wherein the output subsystem effects said conversion by using a remote conversion service.

18. A device according to claim 11, further comprising a wireless output interface, the output subsystem being operative to output the location data via the wireless interface at intervals.

19. A device according to claim 11, further comprising a network interface, the output subsystem being operative to output said location data in response to a location request received over the network.
